(19) United States
(12) Patent Application Publication
(10) Pub. No.: US 2025/0115971 A1
(43) Pub. Date: Apr. 10, 2025

(54) SOLID OXIDE ELECTROLYZER CELL (SOEC) SYSTEM INTEGRATION WITH DIRECT IRON REDUCTION

(71) Applicant: Bloom Energy Corporation, San Jose, CA (US)

(72) Inventors: David Weingaertner, San Jose, CA (US); Jake Immonen, San Jose, CA (US); Jittisa Ketkaew, San Jose, CA (US)

(21) Appl. No.: 18/908,276

(22) Filed: Oct. 7, 2024

Related U.S. Application Data
(60) Provisional application No. 63/542,801, filed on Oct. 6, 2023.

(51) Int. Cl. C21C 5/52

(52) U.S. Cl. CPC C21C 5/52; C21C 2100/02; C21C 2100/04

(57) ABSTRACT

Disclosed are systems and methods for efficiently integrating solid oxide electrolyzer cell (SOEC) systems with direct reduction (DR) processes. In various embodiments, a DR furnace produces steam in an exhaust stream. The exhaust stream is input to an inlet of a SOEC system. The SOEC system uses the steam to generate hydrogen and provide the hydrogen as a reducing agent to the DR furnace. The overall system efficiency may be improved by expelling the hydrogen from the SOEC system at higher temperatures than normal by not internally recycling the output stream of the SOEC system. System cost is reduced by removing components normally used for internal recycling. Additional efficiencies may be gained by capturing thermal energy released at various stages of the process and routing the captured thermal energy to other heating stages of the process.

### CROSS REFERENCE TO RELATED APPLICATIONS

This application claims priority to and the benefit of U.S. Provisional Patent Application No. 63/542,801, titled “SOEC INTEGRATION WITH DIRECT IRON REDUCTION,” filed Oct. 6, 2023, the content of which is incorporated herein by reference in its entirety for all purposes.

### FIELD OF THE TECHNOLOGY

Embodiments disclosed herein generally relate to Solid Oxide Electrolyzer Cell (SOEC) technology, and more particularly, SOEC integration with direct iron reduction.

### BACKGROUND

One process to make direct reduced iron (DRI) from iron ore (e.g., comprised of iron oxide, Fe₂O₃ and/or Fe₃O₄) is through a direct reduction furnace. DRI is used in steel making by sending the DRI to an electric arc furnace (EAF). In DRI furnaces, a synthesis gas (e.g., a mixture of carbon monoxide, CO, and hydrogen, H₂) is fed upward through the furnace to reduce iron ore pellets into metallic iron. The iron (Fe) falls down via gravity. The resulting product, metallic iron and non-reacting inert earth material, is called DRI. A synthesis gas can be provided by steam methane reforming where natural gas is reformed to produce carbon monoxide and hydrogen.

In DRI processes utilizing carbon monoxide and hydrogen gases, iron oxide is reduced to metallic iron according to the following reactions which occur at high temperature (e.g., greater than 600° C.):

Fe₂O₃+3H₂↔2Fe+3H₂O; and

Fe₂O₃+3CO+↔2Fe+3CO₂.

To ensure reducing conditions throughout the DRI furnace, the ratios of H₂ to H₂O and CO to CO₂ need to be kept high, meaning that not all of the reducing gases (H₂ and CO) are consumed in a single pass. To account for this, a large portion of the gas exiting the DRI furnace is recycled back to the beginning of the process after a dust removal step (e.g., a top gas scrubber). The gas that is recycled is then combined with fresh natural gas. The reducing gas that is not recycled is used for combustion to provide heat for the reforming process. This ensures that all the natural gas used for the process is either reacted for reducing gas purposes or combusted for process heat.

In some processes, H₂ originates from an external process (e.g., from an electrolyzer so that it can be carbon neutral, whether it be alkaline, PEM, or SOEC) and is then heated up to temperatures required for the DRI shaft furnace. The heat may be provided by combusting unreacted hydrogen coming out of the shaft furnace as well as an external source. Heat also may be provided from electric resistive heating.

One main drawback of current processes and DRI furnaces that use synthesis gas is their CO₂ emissions from the reaction itself and from the combustion byproduct. In contrast, other solutions utilize external H₂ added from electrolyzers to lower the amount of CO required, as well as processes that exclusively run on hydrogen. In these alternative processes, no natural gas reforming step is required. One drawback of using only H₂ is that it is an endothermic reaction whereas the reaction with carbon monoxide is exothermic. As a consequence, when using only H₂, additional heat may be required, which could make the process less energy efficient.

### SUMMARY

The present invention is directed to SOEC integration with direct iron reduction. Additional features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

SOEC integration with direct iron reduction includes an electrolyzer system, comprising an electrolyzer configured to generate hydrogen using wet hydrogen, wherein a hydrogen and steam exhaust stream is not recycled back to a hotbox of the electrolyzer system. The electrolyzer system is used to generate H₂ for direct reduction of iron (DRI) operations.

One general aspect includes a system including a direct reduction (DR) furnace that produces a DR furnace exhaust stream that includes hydrogen and steam. The DR furnace may include a DR furnace outlet configured to release the DR furnace exhaust stream and a DR furnace inlet configured to receive a reducing agent that includes hydrogen for a DR process. The system also includes a solid oxide electrolyzer cell (SOEC) system configured to generate an electrolyzer output stream including hydrogen and steam. The SOEC system may include an electrolyzer inlet configured to receive an input including steam. The electrolyzer inlet receives at least some of the DR furnace exhaust stream, and the DR furnace inlet receives the electrolyzer output stream. The SOEC system is configured to not internally recycle the electrolyzer output stream.

Implementations may include one or more of the following features. The system may include a conduit configured to supply at least some of the DR furnace exhaust stream to the electrolyzer inlet and a water source coupled to the conduit and configured to supply make-up water to the electrolyzer inlet. The make-up water is converted to steam by mixing with the DR furnace exhaust stream.

In some embodiments, the system includes an electric arc furnace that produces an off-gas. The system may also include a conduit that supplies the DR furnace exhaust stream to the electrolyzer inlet, and another conduit coupled to the first conduit that purges a portion of the DR furnace exhaust stream. The system may also include a mixed furnace coupled to the electrolyzer outlet and the DR furnace inlet. The mixed furnace heats the electrolyzer output stream using, at least in part, heat from the off-gas and heat from the purged portion of the DR furnace exhaust stream.

In some embodiments, the system may include the conduit configured to supply the DR furnace exhaust stream to the electrolyzer inlet. The system may also include the water source coupled to the conduit and configured to supply the make-up water to the electrolyzer inlet. The system may also include a heater coupled to the water source and configured to convert at least a portion of the make-up water into steam.

In some embodiments, the system may include a second heater coupled to the conduit and the first heater. The second heater may be configured to capture heat from the DR furnace exhaust stream and provide the heat to the first heater such that the first heater uses the heat from the purged DR furnace exhaust stream to convert some or all of the make-up water into steam. In some embodiments, the second heater converts some of the make-up water to steam and the rest of the make-up water is converted to steam by mixing with the DR furnace exhaust stream.

In some embodiments, the system includes an impurity remover between the DR furnace outlet and the electrolyzer inlet. The impurity remover is configured to remove impurities from the DR furnace exhaust stream.

In some embodiments, the DR furnace reduces iron ore pellets into metallic iron. In some embodiments, the iron ore pellets are preheated before being input to the DR furnace. To preheat the iron ore pellets, the system may include a combustor configured to use heat from the purged DR furnace exhaust stream and to preheat the iron ore pellets.

In some embodiments, the SOEC system does not include a cathode product cooler or a recycle blower. In some embodiments, the SOEC system includes SOEC stacks of SOECs, and the number of SOECs in the SOEC stacks is increased to fill a vacant space from not including the cathode product cooler.

Another general aspect includes a method. The method includes generating, with a solid oxide electrolyzer cell (SOEC) system, an electrolyzer output stream that includes hydrogen and steam. The electrolyzer output stream is generated using an input stream that includes steam. The method further includes supplying the electrolyzer output stream as a reducing agent to a direct reduction (DR) furnace and performing the DR process with the DR furnace using the reducing agent. During the DR process, the DR furnace produces an exhaust stream that includes hydrogen and steam. The method further includes supplying the DR furnace exhaust stream as at least a portion of the inlet stream to the SOEC system, where the SOEC system does not internally recycle the electrolyzer output stream.

Implementations may include one or more of the following features. The method may include supplying make-up water to the DR furnace exhaust stream to form the inlet stream. The make-up water may be converted to steam by mixing with the DR furnace exhaust stream.

In some embodiments, the method may include capturing an off-gas from an electric arc furnace used in the DR process and purging a purge portion of the DR furnace exhaust stream. The method may further include supplying the off-gas and the purge portion to a mixed furnace as a heat source and heating the electrolyzer output stream with the mixed furnace.

In some embodiments, the method may include supplying make-up water to the DR furnace exhaust stream to form the inlet stream and converting at least some of the make-up water to steam prior to supplying the make-up water to the DR furnace exhaust stream.

In some embodiments, the method may include capturing heat from the DR furnace exhaust stream and using the heat to convert the at least some of the make-up water to steam. In some embodiments only some of the make-up water is converted to steam prior to supplying the make-up water to the DR furnace exhaust stream, and the rest is converted to steam by mixing with the DR furnace exhaust stream.

In some embodiments, the method may include removing impurities from the DR furnace exhaust stream. The impurities may be removed with a zinc oxide bed, for example.

In some embodiments, the DR process includes supplying iron ore pellets to the DR furnace and reducing the iron ore pellets to metallic iron with the DR furnace using the reducing agent. The method may further include purging a purge portion of the DR furnace exhaust stream and supplying the purge portion of the DR furnace exhaust stream to a combustor. The method may further include preheating the iron ore pellets with the combustor prior to supplying the iron ore pellets to the DR furnace.

It is to be understood that both the foregoing general description and the following detailed description are examples and explanatory and are intended to provide further explanation of the invention as claimed.

### BRIEF DESCRIPTION OF THE DRAWINGS

In the drawings, like reference characters generally refer to like parts throughout the different views. Also, the drawings are not necessarily to scale, with an emphasis instead generally being placed upon illustrating the principles of the technology disclosed. In the following description, various implementations are described with reference to the following drawings.

FIG. 1 illustrates a system that integrates a solid oxide electrolyzer cell (SOEC) system with a direct reduction process, according to some embodiments.

FIG. 2 illustrates a system that integrates a solid oxide electrolyzer cell (SOEC) system with a direct reduction process that feeds the exhaust of the direct reduction furnace to the input of the SOEC system, according to some embodiments.

FIG. 3 illustrates another system that integrates a solid oxide electrolyzer cell (SOEC) system with a direct reduction process that feeds the exhaust of the direct reduction furnace to the input of the SOEC system without preheating make-up water, according to some embodiments.

FIG. 4 illustrates another system that integrates a solid oxide electrolyzer cell (SOEC) system with a direct reduction process that feeds the exhaust of the direct reduction furnace to the input of the SOEC system and uses off-gas from the electric arc furnace to heat the SOEC output stream before inputting it to the direct reduction furnace, according to some embodiments.

FIG. 5 illustrates a block diagram of components and product flow for preheating iron ore pellets of the direct reduction process, according to some embodiments.

FIG. 6 illustrates a portion of the SOEC system, according to some embodiments.

FIG. 7 illustrates a method for efficiently integrating an SOEC system with a direct reduction process, according to some embodiments.

FIG. 8 illustrates a perspective view of an exemplary modular SOEC system, according to various embodiments of the present disclosure.

### DETAILED DESCRIPTION

Various embodiments of the present invention provide systems and methods for integrating a solid oxide electrolyzer cell (SOEC) system with a direct reduction process. The direct reduction (DR) process may be used to create DR iron from iron ore pellets. The DR furnace used to reduce the iron ore pellets generates exhaust that includes hydrogen and steam. The exhaust can be used as input to the SOEC system that generates hydrogen from the steam. The generated hydrogen can be supplied to the DR furnace as a reducing agent. In this way, the output of the DR furnace is efficiently used by the SOEC system, and the hydrogen generated by the SOEC system is efficiently used by the DR furnace. Additional efficiencies can be gained by configuring the overall system to limit extraneous cooling, capture heat from portions of the system that would otherwise be lost, and use the captured heat in other areas of the process. Details are described further in the description of the various embodiments shown in the following figures.

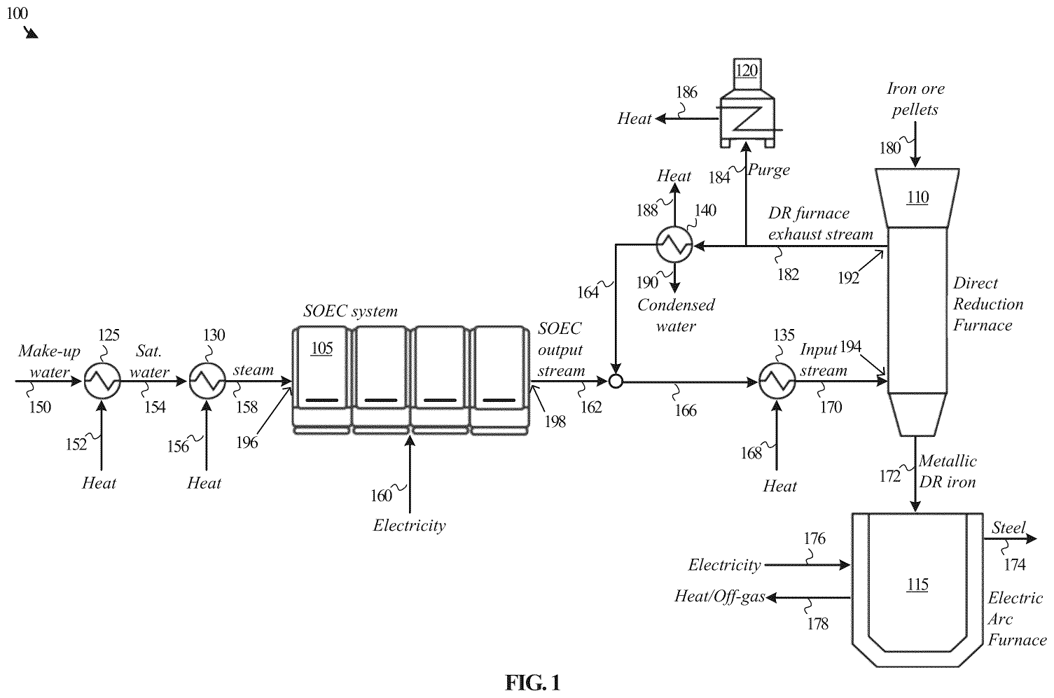

FIG. 1 illustrates system 100 that integrates a solid oxide electrolyzer cell (SOEC) system 105 with a direct reduction process that includes direct reduction furnace 110 and electric arc furnace 115. System 100 includes SOEC system 105, direct reduction (DR) furnace 110, electric arc furnace 115, furnace 120, and heaters 125, 130, 135.

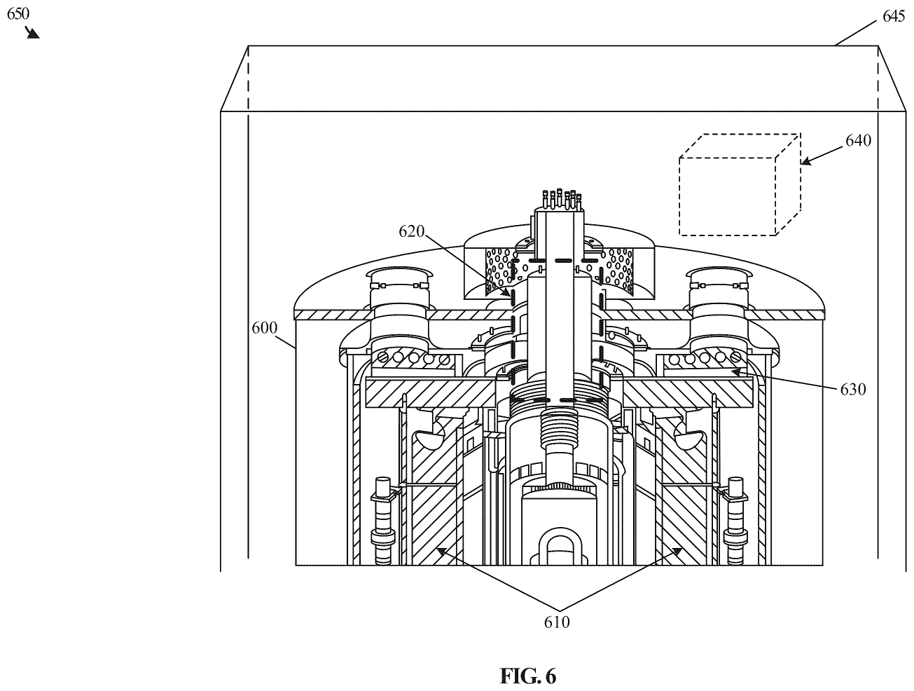

SOEC system 105 is configured to provide fresh hydrogen to DR furnace 110. SOEC system 105 is described in additional detail with respect to FIG. 6. SOEC system 105 is an electrochemical device that operates at high temperatures (e.g., 650-900° C.) to convert water (H₂O) into hydrogen (H₂) using electricity. This process, known as high-temperature electrolysis, is highly efficient and leverages the thermal energy to reduce the electrical energy required for electrolysis. SOEC system 105 includes inlet 196 for receiving an input stream that includes vaporized water (i.e., steam). SOEC system 105 also receives electricity 160 for performing electrolysis. Electricity 160 may be, for example, 90-130 MWₑ. SOEC system 105 includes an outlet 198 for releasing the generated hydrogen in the SOEC output stream 162. SOEC output stream 162 exits outlet 198 at ˜140° C. (e.g., 125-155° C.) and includes ˜85 mol % H₂/15 mol % H₂O (e.g., 75 mol % H₂/25 mol % H₂O-90 mol % H₂/10 mol % H₂O). All values for temperatures and concentrations provided herein are exemplary. Values provided may fall within a range of values that may be used or generated by the components of the systems described herein, including system 100.

DR furnace 110 reduces iron ore pellets 180 to metallic iron (i.e., DRI) 172 using hydrogen as a reducing agent. DR furnace 110 uses the hydrogen generated by SOEC system 105 for the reducing agent. DR furnace 110 includes inlet 194 for receiving the reducing agent (e.g., SOEC output stream 162). Upon reducing iron ore pellets 180, DR furnace 110 drops the metallic iron 172 into electric arc furnace 115. Metallic iron 172 may be produced at ˜1000 tonnes per day (TPD). Electric arc furnace 115 uses electricity 176 to melt the metallic iron 172 to generate steel 174 (e.g., molten steel). Electricity 176 may be ˜14.5 MWₑ (e.g., 14-15 MWₑ) Steel 174 may be produced at ˜930 tonnes per day. Electric arc furnace 115 produces heat and off-gas 178 from the process of generating steel 174. Heat and off-gas 178 may be ˜9.5 MWₜₕ (e.g., 9-10 MWₜₕ). DR furnace 110 produces DR furnace exhaust stream 182 from the reduction process. DR furnace exhaust stream 182 may transfer between outlet 192 of DR furnace 110 and ultimately to inlet 196 of SOEC system 105 via a conduit. All streams depicted in FIGS. 1-4 may travel via conduits coupled as shown in the FIGS. DR furnace exhaust stream 182 may be ˜350° C. (e.g., 320-370° C.) and include ˜63 mol % H₂/37 mol % H₂O (e.g., 60 mol % H₂/40 mol % H₂O−70 mol % H₂/30 mol % H₂O). DR furnace exhaust stream 182 is released from direct reduction furnace 110 at outlet 192.

Furnace 120 may be a hydrogen and air furnace that receives purge gas 184 and produces heat 186 (i.e., thermal energy). The purge gas may be ˜10% (e.g., 5%-15%) of the DR furnace exhaust stream 182. Purge gas 184 may help reduce buildup of inert gasses in system 100. Heat 186 may be released at ˜16 MWₜₕ (e.g., 14-18 MWₜₕ).

Heaters 125, 130, 135 may be any suitable heaters for adding heat to liquid or gas. Each of heaters 125, 130, 135 may be any type of heater or heat exchanger including, for example, shell and tube heat exchanger, plate heat exchanger, air-to-air heat exchanger, counterflow or parallel flow heat exchanger, finned tube heat exchanger, or the like. Cooler 140 may be any suitable cooler for removing heat from liquid or gas. Cooler 140 may be a heat exchanger. Heater 125 heats make-up water 150 to saturated water 154 using heat 152. Make-up water 150 may be provided at ˜10° C. (e.g., 5-15° C.) at an absolute pressure of ˜5.5 bara (e.g., 4.5-6.5 bara). Heat 152 may be ˜4.7 MWₜₕ (e.g., 4-5.5 MWₜₕ) In some embodiments, a portion of heat 186 may be used to provide heat 152 to heater 125. Saturated water 154 may be heated to ˜156° C. (e.g., 140-170° C.) by heater 125, and the pressure may remain the same as make-up water 150. Heater 130 heats saturated water 154 to the point of vaporization, producing steam 158. In some embodiments, a portion of heat 186 may be used to provide heat 156 to heater 130. Heat 156 may be ˜16 MWₜₕ (e.g., 15-17 MWₜₕ). Saturated water 154 may be vaporized by latent heating provided by heater 130 such that steam 158 remains at the same temperature, for example, ˜156° C. (e.g., 140-170° C.). The pressure of steam 158 may remain the same as make-up water 150 at, for example, ˜5.5 bara.

Cooler 140 cools DR furnace exhaust stream 182 after purge 184 purges any purge portion. As mentioned above, DR furnace exhaust stream 182 may exit outlet 192 at ˜350° C. and include ˜63 mol % H₂/37 mol % H₂O. Cooler 140 may provide cooled DR furnace exhaust stream 164 at ˜40° C. (e.g., 30-50° C.) and include ˜92.6 mol % H₂/7.4 mol % H₂O (e.g., 92 mol % H₂/8 mol % H₂O-93 mol % H₂/7 mol % H₂O) after cooler 140 extracts condensed water 190 and releases heat 188. Heat 188 may be ˜22.2 MWₜₕ (e.g., 21.5-23.0 MWₜₕ).

Heater 135 heats the combination 166 of cooled DR furnace exhaust 164 and SOEC output stream 162 using heat 168. Heat 168 may be ˜27.6 MWₜₕ (e.g., 27-28 MWₜₕ). Combination 166 may enter heater 135 at ˜85° C. (e.g., 80-90° C.) and include ˜90 mol % H₂/10 mol % H₂O (e.g., 85 mol % H₂/15 mol % H₂O—93 mol % H₂/7 mol % H₂O). The result is input stream 170 heated to ˜900° C. (e.g., 800-1000° C.). Input stream 170 includes the hydrogen reducing agent used by DR furnace 110.

In use, starting from the left side of FIG. 1, make-up water 150 is heated by heater 125 and saturated water 154 produced by heater 125 is heated by heater 130 to generate steam 158. Steam 158 is supplied to SOEC system 105 via inlet 196. SOEC system 105 uses electricity 160 to generate SOEC output stream 162, which includes hydrogen and steam. SOEC output stream 162 exits SOEC system at outlet 198. SOEC output stream 162 is combined with cooled DR furnace exhaust stream 164, which has a higher concentration of hydrogen due to condensing water out by cooler 140. Combined stream 166 is heated by heater 135 to provide input stream 170 to DR furnace 110 via inlet 194. DR furnace 110 reduces iron ore pellets 180 to metallic iron 172, which drops into electric arc furnace 115. Electric arc furnace 115 heats metallic iron 172 and generates steel 174. DR furnace 110 also produces DR furnace exhaust stream 182, which exits DR furnace 110 at outlet 192. Purge 184 purges a portion of DR furnace exhaust stream 182, and cooler 140 cools the unpurged portion to create cooled DR furnace exhaust stream 164. Furnace 120 heats purge 184 and releases heat 186, some of which may be used by heater 125 and/or 130 to heat make-up water 150 and convert it to steam 158. From there the process continues as a steady state process that operates in a continuous loop.

The present disclosure discusses system 100 in steady state. Other components may be used for startup, shutdown, and/or any transition states of system 100.

One benefit of the configuration depicted in system 100 is that impurities (e.g., dust, sulfur, etc.) present in DR furnace exhaust stream 182 exiting DR furnace 110 at outlet 192 cannot adversely impact SOEC system 105 since DR furnace exhaust stream 182 is not looped back to inlet 196 of SOEC system 105.

Notwithstanding that benefit, a more efficient way for SOEC system 105 to operate is to recycle DR furnace exhaust stream 182 back to inlet 196. The benefit of this can be shown by looking at an overall reaction of this process.

Fe₂O₃+3H₂↔2Fe+3H₂O; and

3H₂O↔3H₂+1.5O₂;

Overall: Fe₂O₃↔2Fe+1.5O₂.

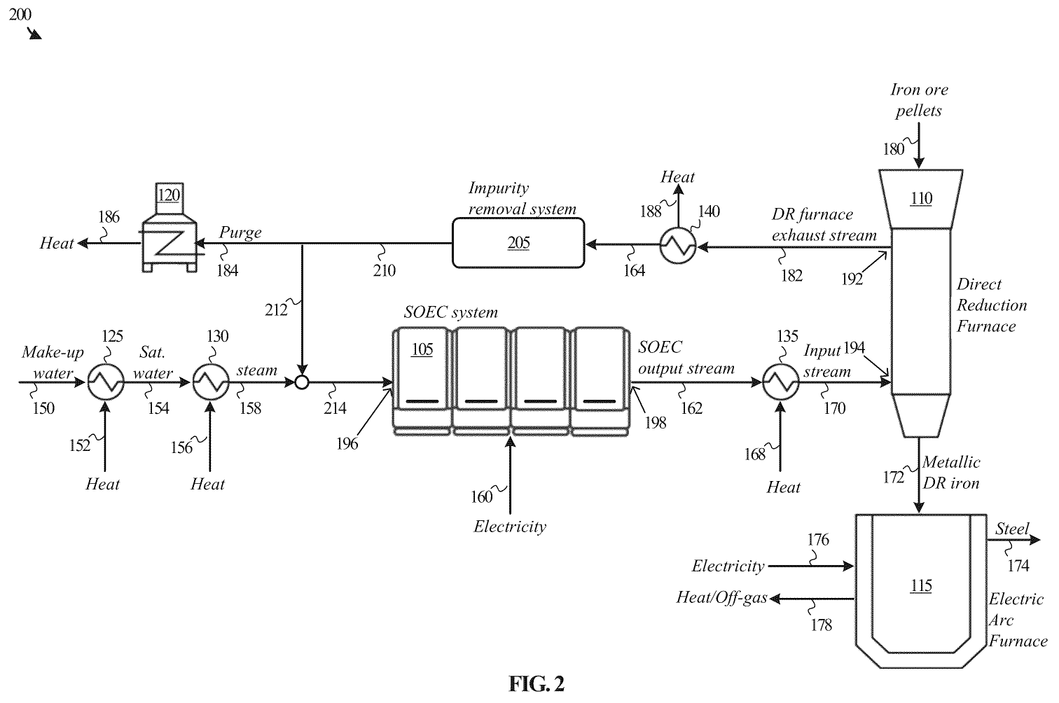

From the overall reaction, the steam generated by DR furnace 110 and provided in DR furnace exhaust stream 182 is then consumed to re-generate H₂ in SOEC system 105. Essentially, hydrogen becomes an oxygen carrier that takes oxygen from the iron oxide ore and removes it via the air side of SOEC system 105 electrolyzers. In the resulting recycle loop, hydrogen atoms are recycled. Due to the buildup of inert components such as nitrogen, some of DR furnace exhaust stream 182 is purged (e.g., purge 184) and make-up water 150 is supplied/used to compensate for the lost water. FIGS. 2-4 depict embodiments of systems that recycle DR furnace exhaust stream 182 to inlet 196 of SOEC system 105.

FIG. 2 illustrates system 200 that integrates SOEC system 105 with the direct reduction process that feeds DR furnace exhaust stream 182 from DR furnace 110 to inlet 196 of SOEC system 105.

As illustrated in FIG. 2, overall input stream 214 to SOEC system 105 is a mix of steam 158 and DR furnace exhaust stream 182 (including hydrogen and steam as discussed above) from DR furnace 110 after cooling DR furnace exhaust stream 182 with cooler 140, removing impurities with impurity removal system 205, and purging a purge portion 184.

Impurity removal system 205 may remove dust, sulfur, and any other impurities from cooled DR furnace exhaust stream 164. Impurity removal system 205 may be, for example, one or more zinc oxide beds. Cleaned DR furnace exhaust stream 210 exits impurity removal system 205, and purge 184 purges a purge portion to create stream 212 used to combine with steam 158 to produce input stream 214.

In system 200, temperature and concentration differences may be seen. For example, cooler 140 may release heat 188 at ˜6 MWₜₕ, and since water is not condensed out by cooler 140, cooled DR furnace exhaust stream 164 may exit cooler 140 at ˜160° C. and the same concentration as DR furnace exhaust stream 182. Other values may also differ than those described with respect to FIG. 1. Further, input stream 214 may enter inlet 196 at ˜155° C. and include ˜57 mol % H₂/43 mol % H₂O.

Additionally, heat 188 may be ˜6 MWₜₕ. Heat 188 may be used to preheat make-up water 150 (e.g., using 1.2 MWₜₕ as heat 152 for heater 125) and generate steam 158 (e.g., using 4.1 MWₜₕ as heat 156 for heater 130).

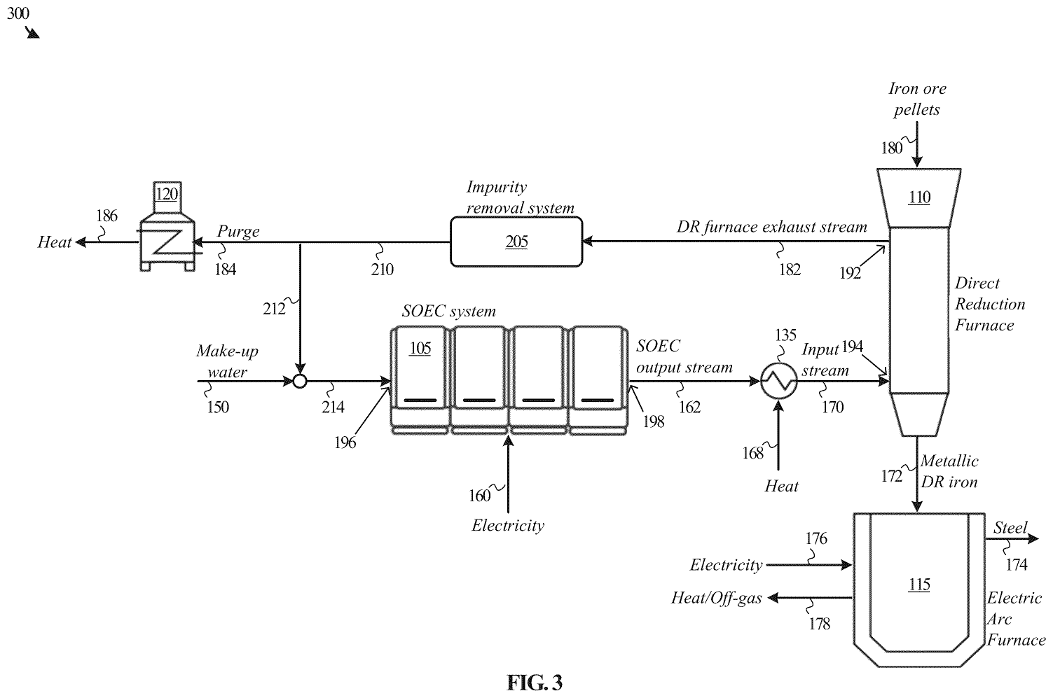

FIG. 3 illustrates system 300 that integrates SOEC system 105 with a direct reduction process that feeds DR furnace exhaust stream 182 of DR furnace 110 to inlet 196 of SOEC system 105 without preheating make-up water 150.

In contrast to system 200, make-up water 150 in system 300 may be pumped into the hot H₂/steam stream 212, causing make-up water 150 to fully vaporize. If the heat content of stream 212 is insufficient to fully vaporize make-up water 150 and maintain the desired temperature of input stream 214 at inlet 196, then only a portion of the water may be preheated and vaporized, leaving less to be vaporized by direct water injection, thereby continuing to raise the overall inlet temperature to SOEC system 100, and thus also raising the temperature at outlet 198 from SOEC system 105.

Note that DR furnace exhaust stream 182 is released at ˜336° C. and includes ˜63 mol % H₂/37 mol % H₂O. Heater (i.e., cooler) 140 is not in system 300, though impurity removal system 205, purge 184, and make-up water 150 may modify the temperature and concentration of input stream 214. As such, input stream 214 may be ˜320° C. and includes ˜57 mol % H₂/43 mol % H₂O. Further, SOEC output stream 162 may exit SOEC system 105 at outlet 198 at ˜140° C. and includes ˜90 mol % H₂/10 mol % H₂O.

As illustrated in FIG. 3, input stream 214 comes from DR furnace exhaust stream 182 of DR furnace 110. In both systems 200 and 300, since input stream 214 already contains H₂, the requirements for SOEC system 105 steady-state operation are reduced. For example, a method to introduce dry hydrogen for startup and/or hot standby may no longer be needed. Additionally, or alternatively, a steam recycle blower within hotboxes of SOEC system 105 to recirculate the H₂ generated at steady-state may no longer be needed. In other words, SOEC system 105 may not internally recycle generated hydrogen or any portion of SOEC output stream to improve efficiency of SOEC system 105 as is typical of SOEC systems. Overall water utilization may be the same as water utilization per pass. As a consequence, more space becomes available for stack height in the same height, width, and depth footprint for each hotbox of SOEC system 105, enabling more SOECs in each hotbox. This may reduce overall system and runtime costs.

Since a steam recycle blower may not be needed for each hotbox in SOEC system 105 in systems 200 and 300, there is no need to keep the temperature of input stream 214 at ˜130-˜160° C. or to keep SOEC output stream 162 at 130-160° C., 180° C. max. Higher inlet 196/outlet 198 temperatures (e.g., 150-300° C.) becomes feasible and may be preferable. Higher inlet 196/outlet 198 temperatures may require SOEC system 105 and systems 200 and 300 generally to utilize valves and other components rated for higher temperatures.

Similarly, without an upper temperature constraint imposed by steam recycle blowers, it may be advantageous to remove cathode product coolers from each hotbox of SOEC system 105 (see FIG. 6 for additional details of internal components of SOEC system 105). As a result, SOEC output stream 162 may have a significantly higher temperature, but would not change the energy consumption per kg H₂ of SOEC system 105. Without the cathode product cooler, more heat exits each hotbox in SOEC output stream 162, instead of in the enriched air product stream. Nominal H₂/steam outlet temperature without a cathode product cooler could be 250 to 350° C. (instead of ˜150° C.). This would reduce the energy required to heat SOEC output stream 162 by heater 135 to 900° C. (e.g., 25 MWₜₕ in systems 200 and 300) as input stream 170.

Elimination of the cathode product cooler has two additional benefits. Elimination reduces the cost of the hotbox and reduces the space requirement at the top of the hotbox, enabling taller columns of SOECs (e.g., 30-60 more SOECs in a column may be accommodated).

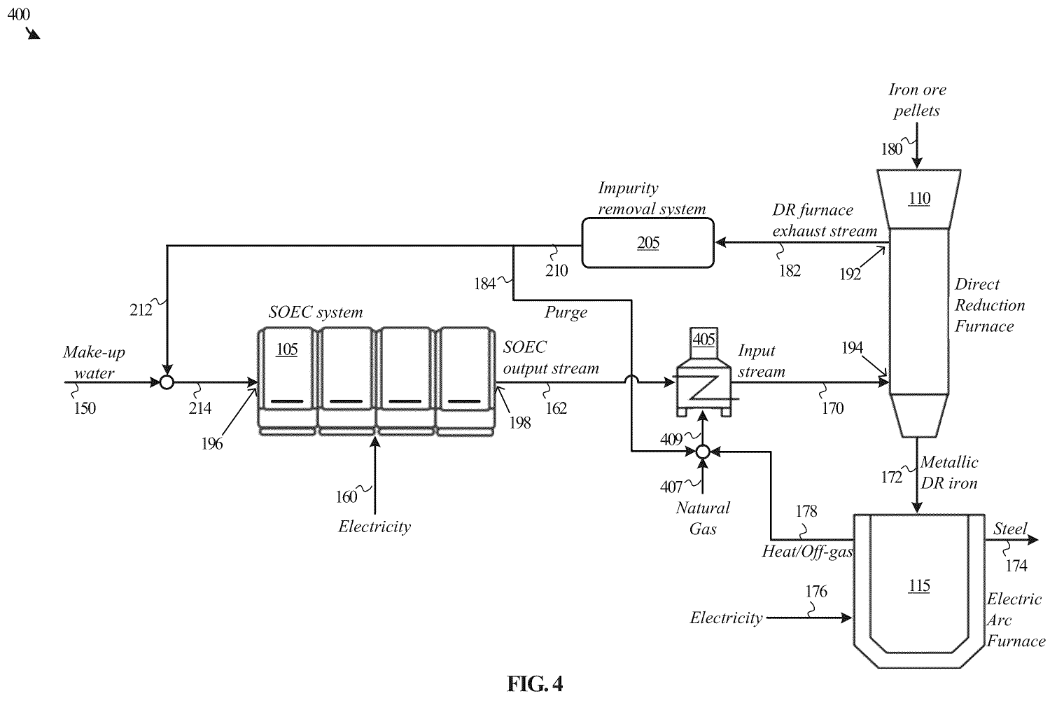

FIG. 4 illustrates system 400 that integrates SOEC system 105 with a direct reduction process that feeds the exhaust of direct reduction furnace 110 to the input of SOEC system 105 and uses heated off-gas 178 from electric arc furnace 115 to heat SOEC output stream 162 before inputting input stream 170 to direct reduction furnace 110.

As illustrated in system 400, make-up water 150 is supplied directly into stream 212 before being supplied to SOEC system 105. The make-up water 150 is vaporized by the heat of stream 212 when mixed. System 400 also includes mixed furnace 405 to heat SOEC output stream 162 to the desired temperature (e.g., 900° C.) utilizing a combination stream 409 of purge gas 184 from DR furnace exhaust stream 182, natural gas 407, and cooled EAF off-gas 178.

Potential heat recovery may be achieved from the EAF off-gas 178 from both sensible and chemical energy from combustion of the carbon monoxide and hydrogen that is present in off-gas 178. Due to the nature of the fluctuation of the temperature of off-gas 178 as well as the composition of off-gas 178, such recovery may be difficult. However, in an example embodiment, off-gas 178 may be cooled and then supplied to mixed furnace 405 that uses purge 184 as well as makeup natural gas 407 to heat SOEC output stream 162 to temperature to provide input stream 170 to DR furnace 110 at inlet 194. Accordingly, problems arising from trying to use a heat exchanger (e.g., heater 135) to get sensible heat from the fluctuating temperature are eliminated. If mixed furnace 405 is used for the combustion of purge 184, then one or more burners that can handle varying gas compositions may also be used. If two EAFs 115 are operating in parallel at 50% out of synchronization, then more uniform chemical energy composition may be achieved as well.

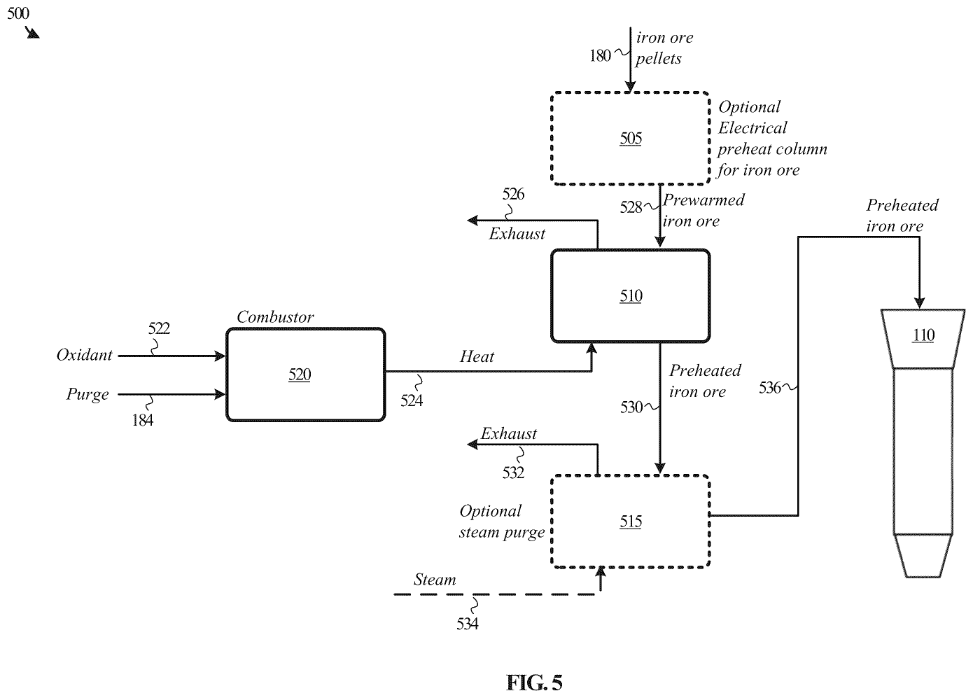

In each of the embodiments of FIGS. 1-4, a portion of DR furnace exhaust stream (i.e., top gas) from DR furnace 110 is utilized as purge gas 184 (e.g., purge may reduce or eliminate N₂ introduced with iron ore pellets 180 to DR furnace 110). This purge gas 184 may still contain a significant fraction of H₂ which could be utilized for several purposes since, when combusted, it could generate ˜15.3 MWh of heat. For instance, as illustrated system 400, the purge gas 184 could be utilized to heat SOEC output stream 162 to generate input stream 170 for furnace 110. Alternatively, purge gas 184 could be used as a combustion heat source to preheat iron ore pellets 180 before they are added to DR furnace 110. For example, purge gas 184 may be combusted with oxidants from air, enriched air exhausted from SOEC system 105, oxygen from an oxygen plant present at a steel making facility, or any combination of those sources. Such preheating is discussed in further detail in FIG. 5.

FIG. 5 illustrates a block diagram 500 of components and product flow for preheating iron ore pellets 180 of the direct reduction process.

As illustrated in block diagram 500, ambient temperature iron ore pellets 180 are provided to a column 505 for optional preheating to a temperature greater than 100° C. The resulting pre-warmed iron ore 528 is then provided to a column 510 where it is further heated by heat 524 generated by combustor 520 to generate preheated iron ore 530. Combustor 520 uses a portion of purge gas 184 and an oxidant 522 (as described above) to generate heat 524. Column 510 may also generate exhaust 526 that can be released to the atmosphere. Without optional steam purge 515, preheated iron ore 536 can be the same as preheated iron ore 530, which is provided to DR furnace 110.

Alternatively, the amount of purge gas 184 may be reduced by purging the preheated iron ore 530 with steam 534 at optional steam purge 515. Optional steam purge 515 may generate steam exhaust 532 that can be released to the atmosphere. Optional steam purge 515 creates preheated iron ore 536, which can then be supplied to DR furnace 110. Doing this may require preheating the iron ore to avoid steam condensation. Here, electrical heating, purge gas combustion products, or a combination thereof may be used, as illustrated in block diagram 500.

FIG. 6 illustrates a partial perspective view of a portion 650 of SOEC system 105. More specifically, portion 650 depicts a portion of one hotbox that may be included in SOEC system 105. As discussed previously, an electrolyzer system, such as solid oxide electrolyzer cell (SOEC) system 105, a reactant flow including water (e.g., steam 158) is separated into hydrogen and oxygen by applying a voltage across the electrolyzer cells (i.e., SOECs). Each hotbox may include one or more SOEC stacks 610, and each SOEC stack 610 may include many SOECs. In the SOEC stack 610, the anode is the air electrode, and the cathode is the reactant or fuel electrode. Thus, the electrode to which the reactant (e.g., steam) is supplied may be referred to as the reactant electrode and the opposing electrode may be referred to as the air electrode in SOECs.

As shown in portion 650, the hotbox contains an outer shell 600 and a plurality of SOEC stacks 610 (also called SOEC columns). The hotbox also contains an air preheater/cathode product cooler 620. An area 630 for a set of water pipes for water preheating may also be present in the hotbox. Dashed volumetric area 640 represents an area occupied by a steam recycle blower that would normally reside outside and above outer shell 600, but inside enclosure 645 of SOEC system 105.

In accordance with the embodiments, air preheater/cathode product cooler 620, water preheating area 630, and the steam recycle blower are not needed to operate SOEC system 105 in systems 200, 300, 400. Water preheating area 630 is not needed since steam is input to the hotbox rather than water. The steam recycle blower and air preheater/cathode product cooler 620 are not needed since the product hydrogen and residual steam are not internally recycled in the embodiments disclosed herein. As a consequence, the height of outer shell 600 within the enclosure 645 of SOEC system 105 can be taller without increasing the height of SOEC system 105 itself. Moreover, the vertical space occupied by the air preheater/cathode product cooler 620, the water preheating area 630, and the steam recycle blower can instead be utilized to make the SOEC stacks 610 taller, thereby increasing the number of SOECs in SOEC system 105, and concomitantly increasing the hydrogen production available from each hotbox in SOEC system 105.

In the various embodiments, steam may be input to SOEC system 105 from an external source or may be generated locally. In some embodiments, multiple steam inlets, including inlet 196, may be configured to receive external and/or local steam, respectively. The steam feed may be generated fully or partially by direct evaporation of water in DR furnace exhaust stream 182 from DR furnace 110.

The primary purpose of the air preheater/cathode product cooler 620 is to cool the product H₂/residual steam (i.e., SOEC output stream 162 and residual steam) to a lower temperature to lower overall power consumption and to reduce the temperature below the maximum temperature of the steam recycle blower (e.g., 180° C., or 200° C.). However, without an upper temperature constraint imposed by the steam recycle blower, it may be advantageous to remove the cathode product cooler 620 from the hotbox. As a result, SOEC output stream 162 has a significantly higher temperature, but would not change the energy consumption per kg H₂. Without the cathode product cooler 620, more heat exits in SOEC output stream 162, instead of in the enriched air product stream.

In accordance with the embodiments, H₂ (i.e., dry H₂) from a separate hydrogen conduit is no longer required. Since input stream 214 to SOEC system 105 already contains H₂ (as shown in systems 200, 300, 400), the requirements for SOEC system 100 steady-state operation are reduced. Thus, a method to introduce dry hydrogen for startup and/or hot standby may no longer be used. There also is no longer a need for a separate hydrogen feed stream or hydrogen recycle steam at steady-state.

In the various embodiments, there are additional hot off-gases 178 from electric arc furnace 115. These off-gases 178 also may be used to provide heat where desired.

In the various embodiments, desulfurization of DR furnace exhaust stream 182 from DR furnace 110 may be achieved using zinc oxide beds. H₂S may be the dominant species. In the temperature ranges described herein, higher temperature generally leads to better performance of the zinc oxide bed for sulfur removal.

In the various embodiments, compression for the recycle stream (i.e., DR furnace exhaust stream 182) is not shown, but may still be used. A compressor may be used to enable closed loop operation. The compressor may be at or adjacent to impurity removal system 205, or more likely, it would be immediately downstream of SOEC system 105.

In addition, while current processes reduce iron in a shaft furnace, that is only one method of direct iron reduction, but the embodiments are not so limited. The embodiments may be readily applied to any direct iron reduction process that uses hydrogen.

While H₂ price is still high, a blend of hydrogen produced by SOEC system 105 and natural gas can be used as a reducing agent for direct iron reduction. SOEC system 105 can be used solely to provide H₂ as the sole reducing agent or be mixed to supplement the existing natural gas supply.

Accordingly, the embodiments efficiently use H₂ produced from SOEC system 105 with direct iron reduction furnaces to produce direct reduced iron (DRI) products including cold DRI (CDRI), hot DRI (HDRI) and Hot briquetted iron (HBI) that are used as feedstock materials for steelmaking.

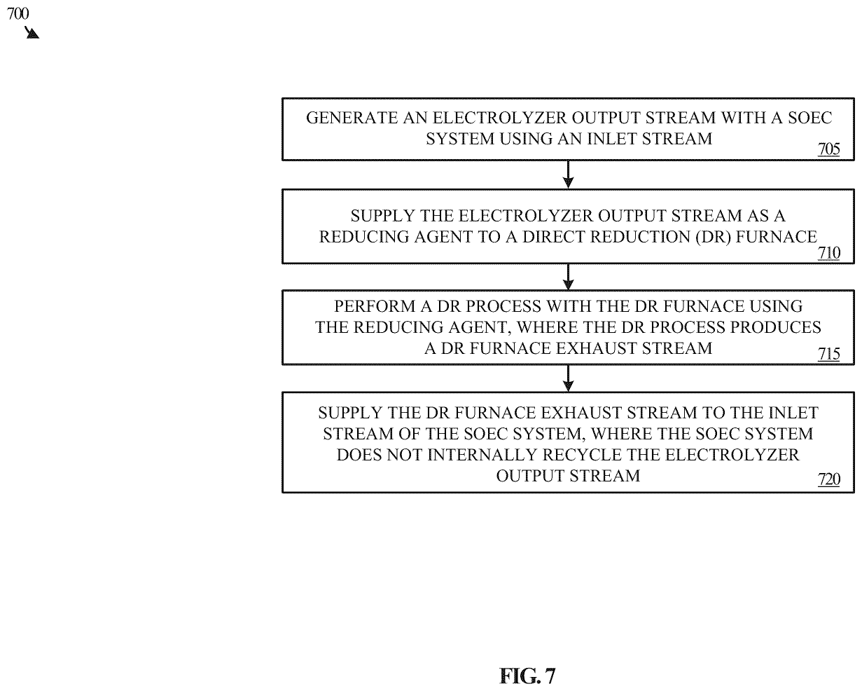

FIG. 7 illustrates a method 700 for efficiently integrating an SOEC system with a direct reduction process. Method 700 includes steps that may be performed using systems 200, 300, or 400. The steps may be performed in a different order and some of the described steps may be optional. At step 705, an SOEC system generates an electrolyzer output stream using an inlet stream. For example, SOEC system 105 generates SOEC output stream 162 using input stream 214 as shown in systems 200, 300, 400.

At step 710, the electrolyzer output stream is supplied as a reducing agent to a DR furnace. For example, SOEC output stream 162 may be provided as input stream 170 to DR furnace 110. In some embodiments, SOEC output stream 162 may be heated by mixing furnace 405 or heater 135 prior to supplying it to DR furnace 110. The hydrogen in SOEC output stream 162 may be the reducing agent used by DR furnace 110. In some embodiments, an off-gas 178 is captured from electric arc furnace 115 and used by mixing furnace 405 to heat SOEC output stream 162. In some embodiments, purge 184 may be used by mixing furnace 405 in addition to or instead of off-gas 178 to heat SOEC output stream 162.

At step 715, a DR process is performed with the DR furnace using the reducing agent. The DR process produces a DR furnace exhaust stream. For example, direct iron reduction of iron ore pellets 180 may be performed by DR furnace 110 using the hydrogen in input stream 170 (which is heated SOEC output stream 162). The DR process includes that DR furnace 110 creates metallic iron 172 from iron ore pellets 180 using the hydrogen, and the metallic iron 172 is supplied to electric arc furnace 115. Electric arc furnace 115 generates steel 174 from the metallic iron 172. DR furnace 110 further generates DR furnace exhaust stream 182, which is expelled from DR furnace 110 via outlet 192.

At step 720, the DR furnace exhaust stream is supplied to the inlet stream of the SOEC system. The SOEC system does not internally recycle the electrolyzer output stream. For example, DR furnace exhaust stream 182 is supplied to SOEC system 105 in input stream 214 via inlet 196. In some embodiments, DR furnace exhaust stream 182 is cooled with cooler 140 before being supplied as input stream 214. In some embodiments, make-up water 150 or steam 158 or a combination is added to DR furnace exhaust stream 182 before being supplied as input stream 214. In some embodiments, make-up water 150 is heated by heaters 125, 130 to generate steam 158. In some embodiments, only a portion of make-up water 150 is converted to steam before adding it to DR furnace exhaust stream 182. In some embodiments, purge 184 is removed from DR furnace exhaust stream 182 before being supplied as input stream 214. In some embodiments, heat is captured from furnace 120 from combusting purge 184, and the heat is used by one or both of heaters 125, 130 to heat make-up water 150. In some embodiments, impurities are removed from DR furnace exhaust stream 182 by impurity removal system 205 before being supplied as input stream 214. Any combination of these optional processes may be done to DR furnace exhaust stream 182 before being supplied as input stream 214.

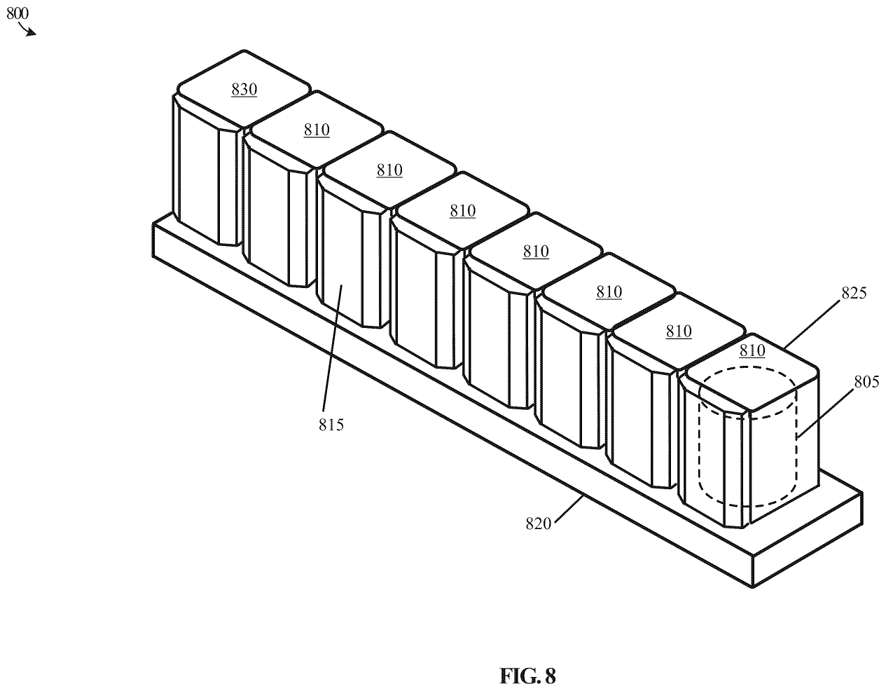

FIG. 8 is a perspective view of a modular SOEC system 800 (e.g., SOEC system 105), according to various embodiments of the present disclosure. The modular design of SOEC system 800 provides flexible system installation and operation. Modules allow scaling of hydrogen generation and flexibility with respect to cost, output, power consumption, and the like with a single design set. This design also provides an easy means of scale up to meet specific requirements of customer installations.

SOEC system 800 includes one or more hydrogen generation modules 810 and one or more power modules 830. Hydrogen generation modules 810 generate hydrogen, and power modules 830, among other things, regulate DC power provided to the hydrogen generation modules 810. SOEC system 800 may also include one or more gas distribution modules (not shown) which are configured to provide start-up hydrogen to SOEC system 800. SOEC system 800 depicted in FIG. 8 includes a row of seven generation modules 810 and one power module 830 disposed on a pad 820. While one row of generation modules 810 is shown, SOEC system 800 may comprise more than one row of generation modules 810. For example, SOEC system 105 may comprise two rows of generation modules 810 arranged back-to-back/end-to-end. Further, while seven generation modules 810 and one power module 830 are depicted, fewer generation modules 810 may be in SOEC system 800. For instance, SOEC system 105, as illustrated in FIGS. 1-4, could include three generation modules 810 and one power module 830.

Each generation module 810 is configured to house one hotbox 805. Each hotbox 805 contains one or more stacks or columns of solid oxide electrolyzer cells (SOECs) (e.g., SOEC stack 610) (not shown in FIG. 8 for clarity). Each SOEC stack includes a number of SOECs having a ceramic oxide electrolyte separated by conductive interconnect plates. A portion of a hotbox 805 is depicted in FIG. 6.

As depicted in FIG. 8, each hotbox 805 is within a modular enclosure 825 (e.g., enclosure 645 depicted in FIG. 6 and schematically depicted in FIGS. 1-4). Each modular enclosure 825 and hotbox 805 collectively form a generation module 810.

Power module 830 includes components for regulating electricity (e.g., electricity 160) supplied to generation modules 810. Power module 830 may regulate power supplied to the stacks/columns in generation modules 810 as well as power supplied to heaters located in generation modules 810.

The linear array of modules 810 is readily scaled. For example, more or fewer generation modules 810 may be provided depending on the hydrogen needs of the DR furnace (e.g., DR furnace 110) or steelmaking facility into which SOEC system 105 is integrated.

SOEC system 105 may be configured in a way to case servicing of the components of the SOEC system 105. For example, the SOEC system 105 may include access doors 815.

The aforementioned discussion is presented to enable any person skilled in the art to make and use the technology disclosed and is provided in the context of a particular application and its requirements. Various modifications to the disclosed implementations will be readily apparent to those skilled in the art, and the general principles defined herein may be applied to other implementations and applications without departing from the spirit and scope of the technology disclosed. Thus, the technology disclosed is not intended to be limited to the implementations shown but is to be accorded the widest scope consistent with the principles and features disclosed herein.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words in the above Detailed Description using the singular or plural number may also include the plural or singular number, respectively. The word “or” in reference to a list of two or more items, covers all of the following interpretations of the word: any of the items in the list, all of the items in the list, and any combination of the items in the list.

The phrases “in some embodiments,” “according to some embodiments,” “in the embodiments shown,” “in other embodiments,” and the like generally mean the particular feature, structure, or characteristic following the phrase is included in at least one implementation of the present technology and may be included in more than one implementation. In addition, such phrases do not necessarily refer to the same embodiments or different embodiments.

The above detailed description of examples of the technology is not intended to be exhaustive or to limit the technology to the precise form disclosed above. While specific examples for the technology are described above for illustrative purposes, various equivalent modifications are possible within the scope of the technology, as those skilled in the relevant art will recognize. For example, while processes or blocks are presented in a given order, alternative implementations may perform routines having steps, or employ systems having blocks, in a different order, and some processes or blocks may be deleted, moved, added, subdivided, combined, and/or modified to provide alternative or subcombinations. Each of these processes or blocks may be implemented in a variety of different ways. Also, while processes or blocks are at times shown as being performed in series, these processes or blocks may instead be performed or implemented in parallel or may be performed at different times. Further any specific numbers noted herein are only examples: alternative implementations may employ differing values or ranges.

What is claimed is:

1. A system, comprising:
a direct reduction (DR) furnace that produces a DR furnace exhaust stream comprising hydrogen and steam, wherein the DR furnace comprises:
a DR furnace outlet configured to release the DR furnace exhaust stream, and
a DR furnace inlet configured to receive a reducing agent comprising hydrogen
for a DR process; and
a solid oxide electrolyzer cell (SOEC) system configured to generate an electrolyzer output stream comprising hydrogen and steam, wherein the SOEC system comprises:
an electrolyzer inlet configured to receive an input comprising steam, and
wherein:
the electrolyzer inlet receives at least a portion of the DR furnace exhaust stream;
the DR furnace inlet receives the electrolyzer output stream; and
the SOEC system is configured to not internally recycle the electrolyzer output stream.

2. The system of claim 1, further comprising:
a conduit configured to supply at least a portion of the DR furnace exhaust stream to the electrolyzer inlet; and
a water source coupled to the conduit and configured to supply make-up water to the electrolyzer inlet, wherein the make-up water is converted to steam by mixing with the DR furnace exhaust stream.

3. The system of claim 1, further comprising:
an electric arc furnace that produces an off-gas;
a first conduit configured to supply a first portion of the DR furnace exhaust stream to the electrolyzer inlet;
a second conduit coupled to the first conduit and configured to purge a second portion of the DR furnace exhaust stream from the first conduit; and
a mixed furnace coupled between an electrolyzer outlet and the DR furnace inlet, wherein the mixed furnace increases a temperature of the electrolyzer output stream using, at least in part, heat from the off-gas and heat from the second portion of the DR furnace exhaust stream.

4. The system of claim 1, further comprising:
a conduit configured to supply at least a portion of the DR furnace exhaust stream to the electrolyzer inlet;
a water source coupled to the conduit and configured to supply make-up water to the electrolyzer inlet; and
a heater coupled to the water source and configured to convert at least a portion of the make-up water into steam.

5. The system of claim 4, wherein the heater is a first heater, the system further comprising:
a second heater coupled to the conduit and the first heater, wherein:
the second heater is configured to capture thermal energy from the DR furnace exhaust stream and provide at least a portion of the thermal energy to the first heater, and
the first heater uses the at least the portion of the thermal energy to convert the at least the portion of the make-up water into steam.

6. The system of claim 4, wherein:
the at least the portion of the make-up water is a first portion, and
a second portion of the make-up water is converted to steam by mixing with the DR furnace exhaust stream.

7. The system of claim 1, further comprising:
an impurity remover coupled between the DR furnace outlet and the electrolyzer inlet, wherein the impurity remover is configured to remove impurities from the DR furnace exhaust stream.

8. The system of claim 1, wherein the DR furnace reduces iron ore pellets into metallic iron.

9. The system of claim 8, further comprising:
a first conduit configured to supply a first portion of the DR furnace exhaust stream to the electrolyzer inlet;
a second conduit coupled to the first conduit and configured to purge a second portion of the DR furnace exhaust stream from the first conduit; and
a combustor configured to use the second portion of the DR furnace exhaust stream to preheat the iron ore pellets.

10. The system of claim 1, wherein the SOEC system does not include a cathode product cooler or a recycle blower.

11. The system of claim 10, wherein the SOEC system comprises a plurality of SOEC stacks, wherein a number of SOECs in each SOEC stack is increased to fill a vacant space from not including the cathode product cooler.

12. A method, comprising:
generating an electrolyzer output stream comprising hydrogen and steam with a solid oxide electrolyzer cell (SOEC) system using an inlet stream comprising steam;
supplying the electrolyzer output stream as a reducing agent to a direct reduction (DR) furnace;
performing a DR process with the DR furnace using the reducing agent, wherein the DR furnace produces a DR furnace exhaust stream comprising hydrogen and steam during the DR process; and
supplying at least a portion of the DR furnace exhaust stream as at least a portion of the inlet stream to the SOEC system, wherein the SOEC system does not internally recycle the electrolyzer output stream.

13. The method of claim 12, further comprising:
supplying make-up water to the at least the portion of the DR furnace exhaust stream to form the at least the portion of the inlet stream, wherein the make-up water is converted to steam by mixing with the at least the portion of the DR furnace exhaust stream.

14. The method of claim 12, further comprising:
capturing an off-gas from an electric arc furnace used in the DR process;
purging a purge portion of the DR furnace exhaust stream;
supplying the off-gas and the purge portion to a mixed furnace as a heat source; and
heating the electrolyzer output stream with the mixed furnace.

15. The method of claim 12, further comprising:
supplying make-up water to the at least the portion of the DR furnace exhaust stream to form the at least the portion of the inlet stream; and
converting at least a portion of the make-up water to steam prior to supplying the make-up water to the at least the portion of the DR furnace exhaust stream.

16. The method of claim 15, further comprising:
capturing thermal energy from the DR furnace exhaust stream; and
using the thermal energy to convert the at least the portion of the make-up water to steam.

17. The method of claim 15, wherein:
the at least the portion of the make-up water is a first portion; and
a second portion of the make-up water is converted to steam by mixing with the at least the portion of the DR furnace exhaust stream.

18. The method of claim 12, further comprising:
removing impurities from the at least the portion of the DR furnace exhaust stream.

19. The method of claim 12, wherein the DR process comprises:
supplying iron ore pellets to the DR furnace; and
reducing the iron ore pellets to metallic iron with the DR furnace using the reducing agent.

20. The method of claim 19, further comprising:
purging a purge portion of the DR furnace exhaust stream;
supplying the purge portion of the DR furnace exhaust stream to a combustor; and
preheating the iron ore pellets with the combustor prior to supplying the iron ore pellets to the DR furnace.
